(19) United States
(12) Patent Application Publication
(10) Pub. No.: US 2005/0116925 A1
(43) Pub. Date: Jun. 2, 2005

(54) Multidimensional input device for navigation and selection of virtual objects, method for controlling a computer unit, and computer system

(76) Inventors: Bernd Gombert, Grafrath (DE); Axel Hildebrandt, Moorenweis-Eismerszell (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/859,638

(22) Filed: Jun. 3, 2004

(30) Foreign Application Priority Data
Jun. 4, 2003 (DE) 103 25 284.3

(51) Int. Cl. G09G 5/00

(52) U.S. Cl. 345/156

(57) ABSTRACT

A computer with a display unit, on which objects displayed in one of several discrete depth levels of display is provided with control signals that are generated by an input device with at least three degrees of freedom. Control signals are evaluated at least in two degrees of freedom for navigation of a cursor or an object on the display unit and control signals of a third degree of freedom are evaluated for choice of one of several discrete detail depth levels of presentation.

### BACKGROUND OF THE DISCLOSURE

1. Field of the Disclosure

The disclosure relates generally to a multidimensional (e.g., three-dimensional) input device and a method for control thereof. The disclosure also relates to the use of such a device for generation of control signals that are used for selection, position, motion, or zoom control during processing of virtual objects or real time navigation of such objects.

2. Description of Related Technology

An example of a force/moment sensor that directly converts the translatory and rotational movements generated by the human hand to translatory and rotational movement speeds of an object being controlled by means of wire strain gauges is disclosed in EP 108 348. The disclosure of EP 108 348 refers to a device for executing a method for programming of movements and optionally processing forces or moments of a robot or manipulator.

A comparable sensor is disclosed in DE 36 11 337 A1, EP 240 023, and U.S. Pat. No. 4,785,180. The base measurement system consists of a light-emitting diode, a slit diaphragm and a linear position detector mounted on the outside relative to a slit diaphragm, which is movable relative to an internal system.

An egg-shaped 3D (three-dimensional) control device for computers, that can be moved freely in space by the hand of the user, determines its instantaneous positions, directions of motion, speeds, and accelerations and transmits these kinematic data in wireless fashion to a computer, is disclosed in U.S. Pat. No. 5,757,360.

It is known from EP 979 990 A2 to use a force/moment sensor to control the operating elements of a real or virtual mixing or control panel, for example, to create and configure color, light, and/or tone compositions.

In the CAD (computer-assisted design) field a pointing device, like a 2D (two-dimensional) mouse or a graphic tablet, is used with one work hand. This means that a change must always be made back and forth between
a “movement mode” (for example, navigation of a cursor to shift or rotate a virtual work piece on the monitor screen) and
a “processing mode” (for example, selection of individual corner points or edges of a rectangular surface of the virtual work piece for enlargement), which leads to continuous interruption of the natural thought and working process.

If the space available on a desk is not sufficient for movement of the 2D mouse during scrolling of a scroll bar or during navigation of the object being controlled, the natural movement process to control these objects must be interrupted. The scrolling or navigation operations being conducted with the mouse under some circumstances must then be restarted by multiple re-gripping movements of the working hand.

There are also comparable problems during navigation in tree-like list structures on a screen. According to the prior art, a selection cursor must first be navigated to a desired location of the directory structure by means of an input device. This ordinarily occurs by activating a so-called scroll bar on the edge of the screen. The cursor must then be moved to the selected site of the directory structure by means of the input device from the scroll bar in order to open new directory levels. This position change interrupts the natural work flow.

### SUMMARY OF THE DISCLOSURE

The disclosure provides a technique that permits navigation and activation processing, for example, for opening/closing of discrete detail/directory levels, without a position change of the user's hand.

According to the disclosure, a method is provided for controlling a computer unit with a display unit on which objects are displayed in one of several discrete detail depth levels of presentation. The method includes generating control signals by an input device with at least three degrees of freedom, evaluating control signals in at least two degrees of freedom for navigation of a mark—e.g. in the form of a cursor—or an object on the display unit, and evaluating a third degree of freedom for selection of one of several discrete detail depth levels.

Preferably, control signals are generated by the input device with at least four degrees of freedom and the fourth degree of freedom of the input device generates control signals that are evaluated for alternate activation or deactivation of an object on the display unit.

The disclosure pertains to a manually operable input device subject to excursion in three dimensions, as well as to the use of such a device for generating control signals that are required for selection, position, movement, or zoom control during processing of virtual 3D objects or in real-time navigation of these objects through a virtual scene. The input device is useful for control and manipulation as well.

The disclosure pertains to the transmission of these control signals to a computer with a display device connected to it for visualization of the controlled movement processes. The disclosed input device has an operating part that is to be operated manually, which can undergo excursion in translatory (x, y, z) and/or rotational degrees of freedom (φₓ, φ_{y}, φ_{z}).

According to the disclosure, the 3D objects being controlled can be moved by means of the manually operated 3D device by manipulation of a force/moment sensor arbitrarily in the six degrees of freedom. Selection and navigation of the objects being controlled then occur by translatory (Δx, Δy, Δz) or rotational excursion (Δφₓ, Δφ_{y}, Δφ_{z}) of the input device in at least two different spatial degrees of freedom (x, y, z, φₓ, φ_{y}, φ_{z}) established beforehand by the manufacturer or user. By excursion of the 3D device in a third degree of freedom, a specified discrete detail depth level (D₁, . . . , Dₙ) can be chosen from a zoom factor list.

Preferably, a control window of a graphic user interface displayed by means of the display unit is opened by excursion of an operating element of the input device in a specific degree of freedom or a combination of previously-established degrees of freedom, whereby the control window shows at least one virtual switch surface for changing adjustments of the input device and whereby the switch surface can be operated by excursion of the operating element in at least one additional degree of freedom or a combination of additional previously-established degrees of freedom.

According to another aspect of the disclosure, a method is provided for controlling a computer unit with a display unit, on which directories and/or files of a tree-like directory with several hierarchical levels are displayed, in which the display directory levels or files are selectable. The method includes generating control signals by an input device with at least three degrees of freedom, evaluating control signals for navigation of a mark—e.g. in the form of a selection cursor—or an object in the directory, and evaluating a third degree of freedom for alternate opening or closing of discrete directory levels or files.

### BRIEF DESCRIPTION OF THE DRAWINGS

Additional attributes, features, advantages, and useful properties of the disclosure may be apparent from the following description of some practical examples, which are depicted in the following drawings. In the drawings

FIG. 1a shows a practical example of a 3D input device used in a system for generation of control signals;

FIG. 1b shows a practical example of a system for generation of control signals;

FIG. 2a shows a flowchart for selection of virtual objects, performance of scaling of the defined image section and displacement of the image section;

FIG. 2b shows a flowchart to explain the procedures that occur in the context of a subprogram-routine for selection of the virtual object or a group of such objects;

FIG. 2c shows a flowchart to explain the processes that occur in the context of a subprogram-routine for navigation of a cursor through a list of stipulated zoom factors;

FIG. 2d shows a flowchart to explain the processes that occur in the context of a subprogram-routine for displacement of a rectangular image section of the depicted virtual scene, as well as virtual objects contained in it;

FIG. 3a shows a flowchart to explain the processes that occur during navigation of a selection cursor through a two-dimensional directory structure and selection of directories or files contained in it;

FIG. 3b shows a flowchart of the processes that occur in the context of a subprogram-routine for navigation of a selection cursor to a directory or file that has the same hierarchical level in the two-dimensional directory structure as the last selected directory or last selected file;

FIG. 3c shows a flowchart of the processes that occur in the context of a subprogram-routine for the navigation of a selection cursor to a directory or file that has a higher or lower hierarchical level in the two-dimensional directory structure than the last selected directory or last selected file;

FIG. 3d shows a flowchart of the processes that occur in the context of a subprogram-routine for navigation of a selection cursor through a list of possible view or arrangement types and changing of the presentation view or arrangement of subdirectories or files depicted in a second partial window of a graphic user interface; and,

FIG. 4 shows an example of a control window.

### DETAILED DESCRIPTION

The functions of the subassemblies and process steps used in individual practical examples are described below. Initially, the design and mechanical components of a 3D input device according to a practical example will be explained.

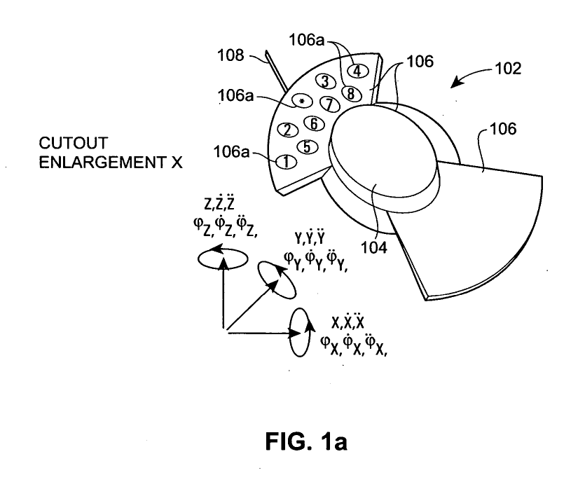

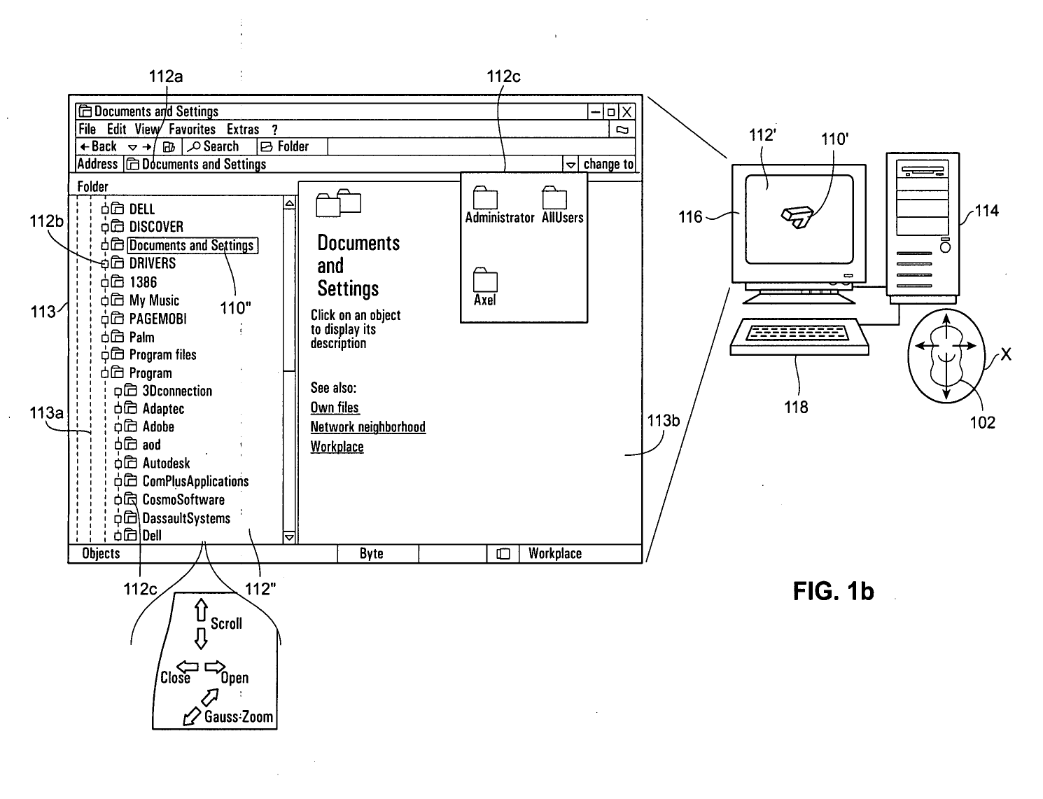

Referring to FIGS. 1a and 1b, a multidimensional (3D, in this case) input device 102 having an operating element 104, when appropriately controlled by the user, is in a position to generate control signals 108 in six independent spatial degrees of freedom. These include three translatory degrees of freedom subsequently referred to as x, y, and z, as well as three rotational degrees of freedom, subsequently referred to as φₓ, φ_{y}, φ_{z}, which denote rotational movements of virtual objects 110′ around the x-, y-, and/or z-axis of a three-dimensional Cartesian coordinate system with pairwise orthogonal axes. Excursions of the operating element 104 in the aforementioned six spatial degrees of freedom are interpreted as control signals for navigation of virtual objects 110′ or of a cursor 110″ through a virtual scene 112′ displayed on a computer screen 116.

The 3D input device 102 depicted in FIG. 1a, for example, comprises the following components:
an operating element 104 (e.g., a force/movement sensor) that can be manipulated with at least one finger or hand of the user,
a base plate 106, on which the operating element 104 is mounted movable in three axes in order to record at any time t
   a force vector \overline{F}(t):=Fₓ(t)·\overline{e}ₓ+F_{y}(t)·\overline{e}_{y}+F_{z}(t)·\overline{e}_{z} and
   a moment vector \overline{M}(t):=Mₓ(t)·\overline{e}ₓ+M_{y}(t)·\overline{e}_{y}+M_{z}(t)·\overline{e}_{z}
   with components Fₓ(t), F_{y}(t), F_{z}(t) or Mₓ(t), M_{y}(t), M_{z}(t) in the direction of the unit or base vectors \overline{e}ₓ, \overline{e}_{y}, and \overline{e}_{z} of a three-dimensional Cartesian coordinate system with the axes x, y, and z as well as optional function keys 106a with programmed standard functions, in which the additional functions can be programmed individually by the user.

These control signals are transmitted to a computer 114 via an interface and converted by the appropriate driver software to corresponding processes on a monitor connected to the computer.

FIG. 1b shows a practical example 100a that can also be used in the same manner in the context of a CAD application, in which the objects, for example, a perspective view of a three-dimensional work piece generated by the computer 114 by means of a CAD application, can be displayed on the monitor 116.

Selection of an object or group of several objects occurs by establishing a rectangular image section of the depicted scene on an equivalent scale by at least four excursions of the operating element 104 in at least two degrees of freedom (x, y, z, φₓ, φ_{y}, φ_{z}) appropriately established beforehand to stipulate the position and size of the image section.

The detail depth level of the depiction is controlled by excursion of the operating element 104 in a third degree of freedom. An additional scaling of the complete scene with the objects contained in it could also be imagined by a first excursion of the operating element 104 in an appropriately pre-stipulated degree of freedom for navigation through a list of stipulated discrete detail depth levels D₁, . . . , Dₙ, as well as a second excursion of the operating element 104 in another degree of freedom for selection of a specific detail depth level.

Furthermore, a control window 100c of a graphic user interface 113 can be opened by excursion of the operating element 104 in a specific degree of freedom (or a combination of previously-established degrees of freedom). The control window shows at least one virtual switch surface for changing the adjustments of the input device 102. A virtual switch surface can be operated by excursion of the operating element 104 in at least one additional degree of freedom or a combination of additional previously-established degrees of freedom, i.e. in a degree of freedom or in degrees of freedom other than the one or ones used for opening the control window. For example, the switch may be provided in the form of a slide switch or slide controller or the like for changing the sensitivity of the input device 102 with respect to translational and/or rotational movements of the virtual object 110′.

According to the practical example 100a specifically depicted in FIG. 1b, use of the aforementioned method for navigation of a cursor 110″, selection, opening and/or closing of directories 112a, b, c and/or files in a two-dimensional tree-like hierarchical directory structure 112″ is prescribed. This directory structure has a root directory 112a and a number of additional subdirectories 112c of lower hierarchical levels branching off from the root directory 112a or one of its subdirectories 112b, and open subdirectories as well as files stored in them. The directory structure 112″ is depicted here in a first partial window 113a of the graphic user interface 113, whereas the subdirectories 112b, c, and/or files contained in a selected directory 112a, b, c are displayed in the second partial window 113b of the graphic user interface 113 and can be clearly identified and sorted by means of graphic symbols, names, type designations, size information, and/or creation dates.

A change in presentation view and/or arrangement of the subdirectories 112b, c, and/or files displayed in the second partial window 113b with respect to name, type, size, or creation date, then occurs by an excursion of the operating element 104 for selection of a specific type of view or arrangement.

This navigation can therefore be carried out, for example, in a directory tree of “Windows Explorer.”

The depicted section of the directory tree can be displaced upward and downward (see the “Scroll” arrow in FIG. 1b) and subdirectories can be opened and closed (“Open” or “Close” arrows in FIG. 1b).

By operating an additional degree of freedom of the input device 102 (diagonal arrow “Gauss-Zoom”) a subdirectory can be optionally opened or closed according to a so-called “Gauss-Zoom.” Similar to the distribution of sensory cells in the human eye and the high resolution of the focused object related to it with a continuous reduction in the direction toward the periphery, opening of the subdirectories is carried out with different opening depth. For the directory currently in focus, several subdirectories are therefore opened, whereas the opening depth in adjacent directories diminishes successively.

Starting from this center of the focus, the opening depth can essentially assume the trend of a (discretized) Gauss distribution. In each case the adjustable zoom factor is therefore a function of the distance from the focal center.

A software driver program package converts the control signals received in the computer 114 from the 3D input device 102 into graphically displayable motion processes of selected objects 110′, 110″ and/or executable control commands during operation on the computer 114, in which at least one degree of freedom is evaluated through selection of one of several discrete detail or directory levels.

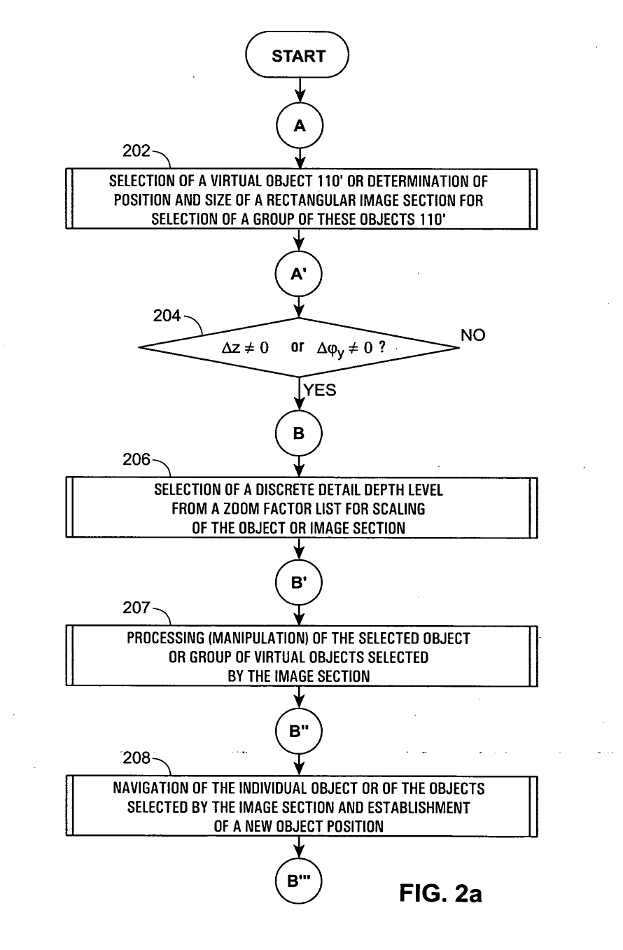

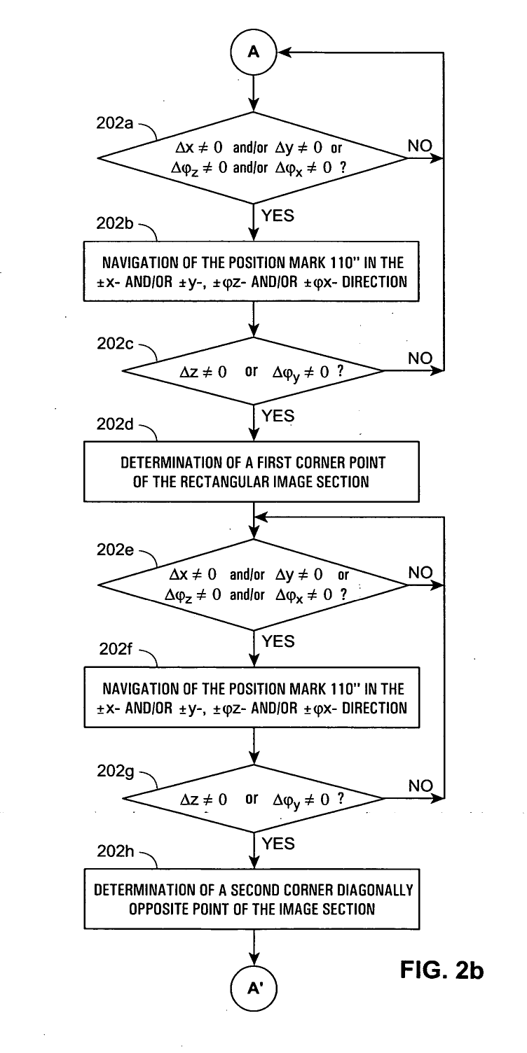

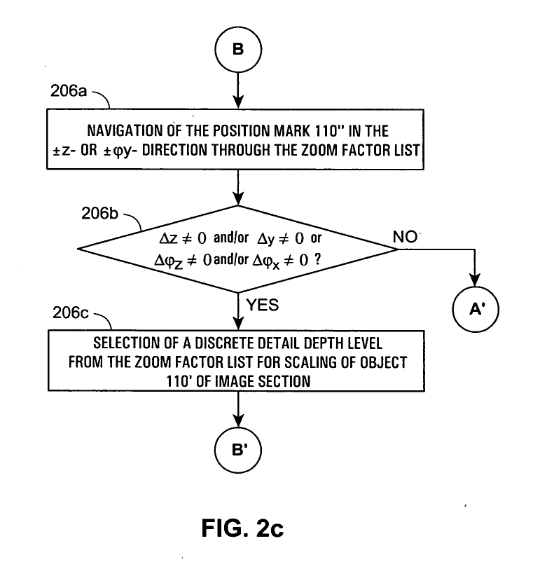

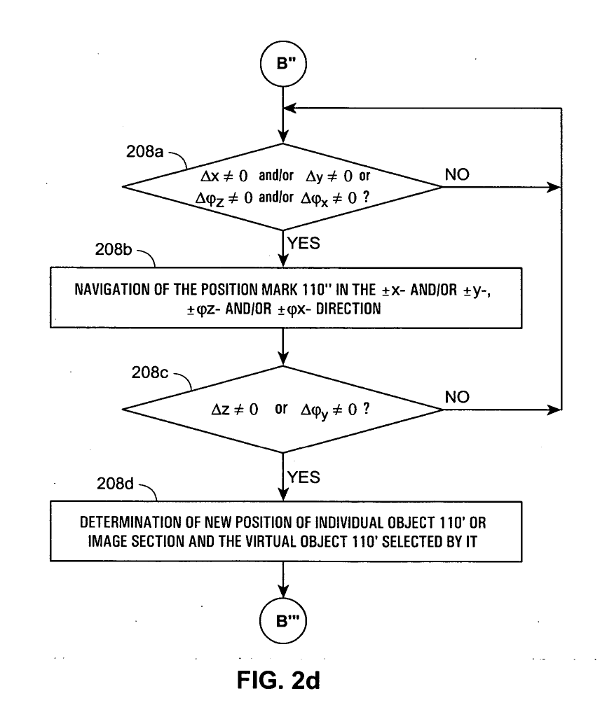

FIGS. 2a and 2b illustrate processes in the environment of a CAD application.

A flowchart to establish an image section of the depicted virtual scene for selection of virtual objects 110′, for execution of scaling of the defined image section and for displacement of the image section by means of excursions of the force/moment sensor 104 in different translatory (x, y, z) and/or rotational degrees of freedom (φₓ, φ_{y}, φ_{z})—incorporated in an endless loop—is presented in FIG. 2a.

FIGS. 2b, 2c, and 2d show flowcharts to explain the processes that occur in the context of subprogram-routines 202, 206, and 208 to establish a rectangular image section for selection of a virtual object 110′ or a group of such objects, for adjustment of a view with the desired detail level and for displacement of a rectangular image section of the depicted virtual scene 112′ and the virtual objects 110′ contained in it.

According to step 202 the position and size of a rectangular image section of the virtual scene 112′ depicted on the screen 116 are initially determined for selection of a virtual object 110′ or a group of such objects by navigation of the cursor 110″ in the ±x- and/or ±y- or in the ±φ_{z}z- and/or ±φₓ-direction to two diagonally opposite corner points of the image section being viewed and confirmation of the positions of these corner points by excursion of the force/moment sensor 104 in the ±z- or in the ±φ_{y}-direction. When an excursion Δx≠0 and/or Δy≠0 or Δφ_{z}≠0 and/or Δφₓ≠0 of the force/moment sensor 104 is recorded in step 202a the cursor 110″ according to step 202b is navigated in the ±x and/or ±y- or ±φ_{z}- and/or ±φₓ-direction through the virtual scene 112″ depicted on the screen 116, in which case the size and direction of the displacement are calculated from the amount and sign of the excursion Δx and/or Δy or Δφ_{z} and/or Δφₓ of the force/moment sensor 104.

After an additional excursion Δz≠0 or Δφ_{y}≠0 of the force/moment sensor 104 is detected in step 202c, establishment of a corner point occurs in step 202d of a rectangular image section required for selection of a virtual object 110′ or a group of such objects of the depicted virtual scene 112′. To establish an additional corner point lying diagonally opposite, an additional navigation operation as well as an additional selection operation is necessary. When an excursion. Δx≠0 and/or Δy≠0 or Δφ_{z}≠0 and/or Δφₓ≠0 of the force/moment sensor 104 is detected in step 202e, the cursor 110″ according to step 202f is navigated in the ±x and/or ±y or ±φ_{z} and/or ±φₓ direction through the virtual scene 112′ depicted on the screen 116, in which case the size and direction of the displacement are again calculated from the amount and sign of the excursion Δx and/or Δy or Δφ_{z} and/or Δφₓ of the force/moment sensor 104. After an additional excursion Δz≠0 or Δφ_{y}≠0 of the force/moment sensor 104 was detected in step 202g, establishment of an additional corner point of a rectangular image section of the depicted virtual scene 112′ required for selection of a virtual object 110′ or a group of such objects occurs in step 202h.

If a repeated excursion Δz≠0 or Δφ_{y}≠0 of the force/moment sensor 104 is detected in step 204, a subprogram-routine 206 is called up to open/close the stipulated (discrete) detail depth levels D₁, . . . , Dₙ.

Depending on the sign of the excursion in the corresponding degree of freedom, successive views are then generated in step 206a in discrete steps with higher or lower detail levels in the sense of a speed control, until the corresponding maximum or minimum value of the detail levels is reached. As soon as the user terminates excursion in this degree of freedom, the last selected “resolution” is considered.

Depending on the sign of the excursion in the corresponding degree of freedom, successive views are then generated in step 206a in discrete steps with higher or lower detail levels in the sense of a speed control, until the corresponding maximum or minimum value of the detail levels is reached. As soon as the user terminates excursion in this degree of freedom, the last selected _{“}resolution” is considered. Thus, a navigation of the cursor through a list of predetermined zoom factors is performed in step 206a. The zoom factor can be used for the scaling of the virtual scene 112′ as well as of the object(s) 110′ displayed therein. Magnitude and direction of the “zoom shifting” is calculated on the basis of the amount and direction of the excursion (Δz or Δφ_{y}).

Subsequently, a request for detection of an excursion Δx≠0 and/or Δy≠0 or Δφ_{z}≠0 and/or Δφₓ≠0 is performed (step 206b) in order to select the specific zoom factor which is determined by the current position (in z- or φ_{y}-direction) of the cursor (step 206c).

Then the object (or group of objects) selected by the image section can be processed or manipulated in step 207.

Subroutine 208 includes steps 208a to 208d. A request for detection of an excursion Δx≠0 and/or Δy≠0 or Δφ_{z}≠0 and/or Δφₓ≠0 is performed in step 208a. In step 208b, the cursor is navigated through the virtual scene 112′ in order to dislocate the rectangular image section as well as the object 110′ or objects included therein. A request for detection of an excursion Δz≠0 or Δφ_{y}≠0 is performed in step 208c in order to determine, i.e. to select an arrival position for the rectangular image section and the object(s) therein (step 208d).

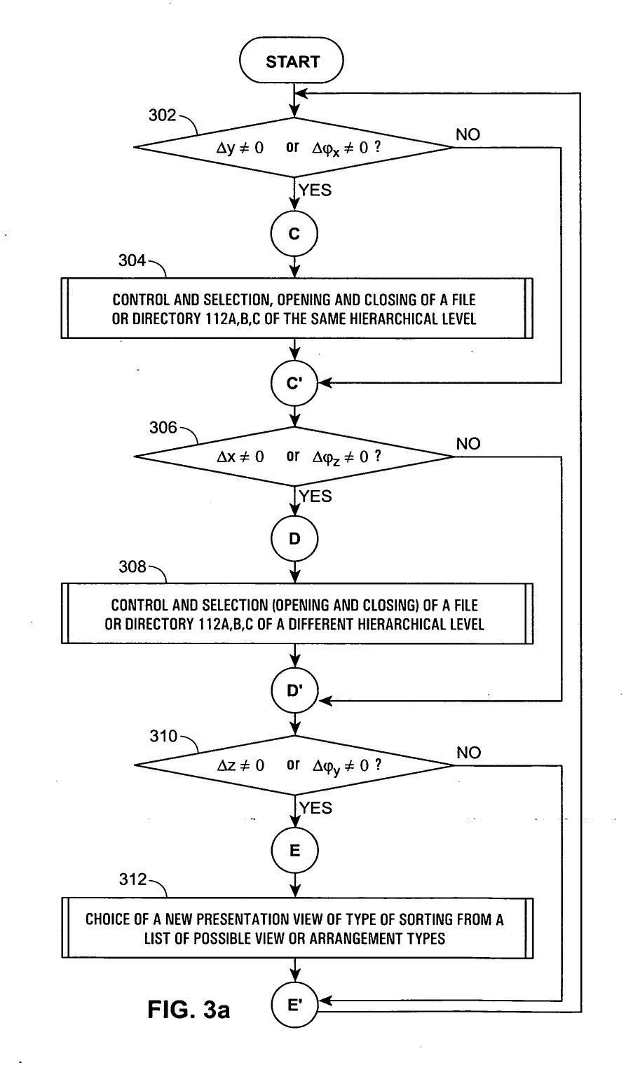

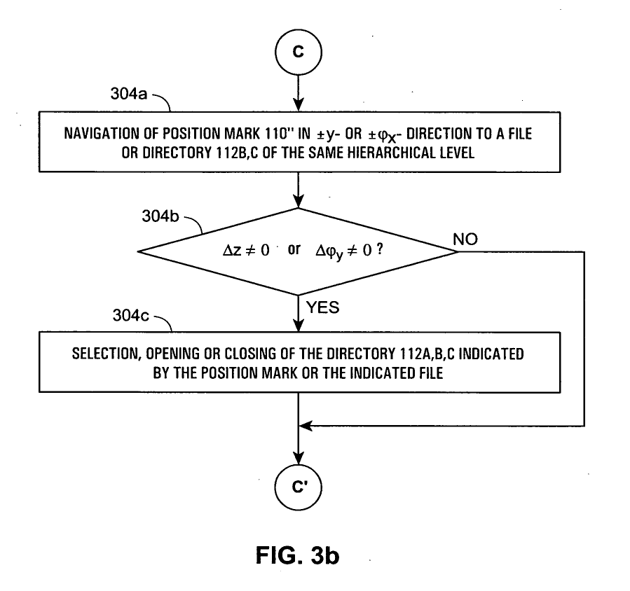

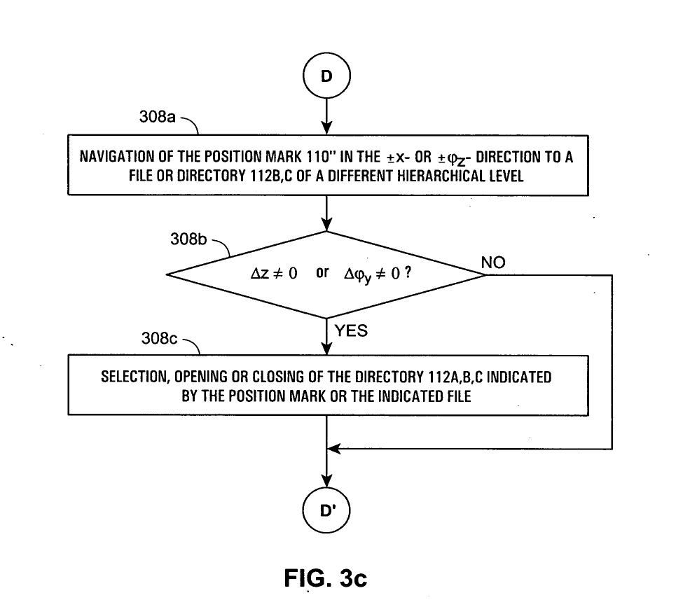

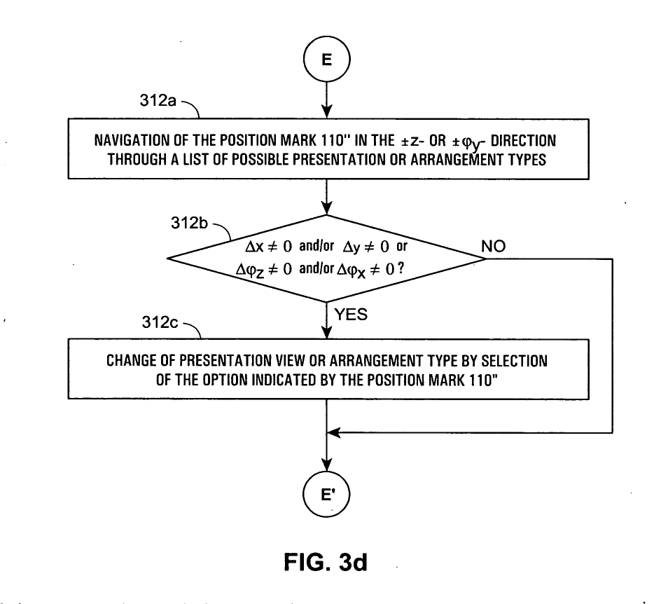

FIGS. 3a and 3b illustrate processes in the environment of a tree-like depiction of directories.

A flowchart is shown in FIG. 3a for navigation of a selection cursor 100″ through a two-dimensional directory structure 112″ and selection of directories 112a, b, c or files contained in it by means of excursions of the force/moment sensor 104 in different translatory (x, y, z) and/or rotational degrees of freedom (φₓ, φ_{y}, φ_{z}).

FIGS. 3b, 3c, and 3d show flowcharts to explain the processes that occur in the context of subprogram-routines 304, 308, and 312 for navigation of the selection cursor 110″ to a directory 112a, b, c, or to a file, that has the same, a higher, or a lower hierarchical level in the two-dimensional directory structure 112″ as the last selected directory 112a, b, c or the last selected file. In addition, the required processes for navigation of selection cursor 110″ through a list of possible view or arrangement types and to change the present view or arrangement of subdirectories 112b, c, or files depicted in the second partial window 113b of the graphic user interface 113 are shown.

When an excursion Δy≠0 or Δφₓ≠0 of the force/moment sensor 104 is detected in step 302, the selection cursor 110″ according to step 304a is navigated to a directory 112a, b, c, or a file that has the same hierarchical level in the two-dimensional directory structure 112″ as the last selected directory 112a, b, c or the last selected file. The size and direction of the displacement are then calculated from the amount and sign of the excursion Δy or Δφₓ. If an excursion Δz≠0 or Δφ_{y}≠0 the force/moment sensor 104 is detected in step 304b, the directory 112a, b, c, or the file indicated by it and shown by the selection cursor 110″ is selected, opened or closed in step 304c, depending on whether the corresponding directory 112a, b, c, or the corresponding file was previously already closed or opened. When an excursion Δx≠0 or Δφ_{z}≠0 of the force/moment sensor 104 is detected in step 306, the selection cursor 110″ according to step 308a is navigated to a directory 112a, b, c, or a file that has a higher or lower hierarchical level in the two-dimensional directory structure 112″ than the last selected directory 112a, b, c, or the last selected file. The size and direction of displacement are again calculated from the amount of sign of the excursion Δx or Δφ_{z}. If an excursion Δz≠0 or Δφ_{y}≠0 of the force/moment sensor 104 is detected in step 308b, the directory 112a, b, c, or the file indicated by it and displayed by the selection cursor 110″ is selected, opened or closed in step 308c, depending on whether the corresponding directory 112a, b, c, or the corresponding file was previously already closed or opened.

Finally, when an excursion Δz≠0 or Δφ_{y}≠0 of the force/moment sensor 104 is detected in step 310, the selection cursor 110″ according to step 312a is navigated through a list of possible view or arrangement types in which different possibilities are provided for sorting of the directories 112a, b, c, and files (for example, according to name, type, size or creation date). If an excursion Δx≠0, Δy≠0, Δφ_{z}≠0, or Δφₓ≠0 of the force/moment sensor 104 is detected in step 312b, according to step 312c a change in presentation view or arrangement occurs in the second partial window 113b of the graphic user interface 113 of the presented subdirectories 112b, c, or files contained in the instantaneously selected directory 112a, b, c.

An advantage of using the disclosed method for directory displays therefore lies the fact that interfering re-gripping movements of the work hand to readjust the input device, which typically occur, for example, during scrolling of the scrollbar or during control of virtual objects with a conventional 2D mouse in the case of a lack of space on the available work surface, are eliminated.

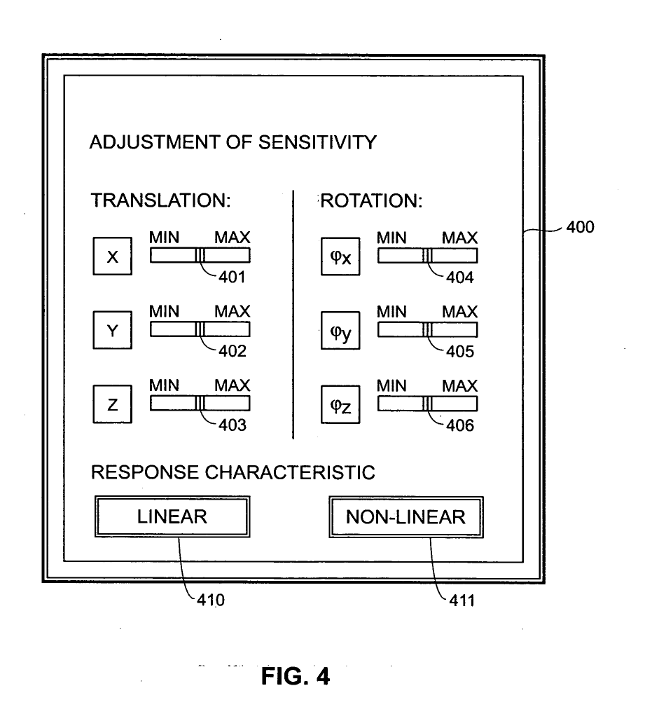

Furthermore, a control window of a graphic user interface can be opened by an excursion of the operating element 104 in a specific degree of freedom (or a combination of previously-established degrees of freedom). FIG. 4 shows an example of such a control window 400. The control window 400 shows at least one virtual switch surface for changing the adjustments of the input device 102. The virtual switch surface can be operated by excursion of the operating element 104 in at least one additional degree of freedom or a combination of additional previously-established degrees of freedom, i.e. in a degree of freedom or in degrees of freedom other than the one or ones used for opening the control window.

For example, the switch may be provided in the form of a slide switch or slide controller or the like for changing the sensitivity of the input device 102 with respect to translational and/or rotational movements of the virtual object 110′. The control window 400 shown in FIG. 4 shows three slide controllers 401, 402, 403 for adjustment of the sensitivity with respect to translational movements in x-, y-, and z-direction, respectively, and three further slide controllers 404, 405, 406 with respect to rotational movements in φₓ, φ_{y}, and φ_{z}-direction, respectively. Furthermore, the control window 400 according to the example shown in FIG. 4 shows two switches in the form of “soft keys” 410, 411 for switching between linear and non-linear response characteristic. The non-linearity of the characteristic may be e.g. a preset characteristic or may be to be adjusted by the user, e.g. by use of a further control window. Therefore, the sensitivity of the input device 102 can be individually adjusted by use of the control window to the specific needs of a user.

1. Method for controlling a computer unit with a display unit on which objects are displayed in one of several discrete detail depth levels of presentation, comprising:
generating control signals by an input device with at least three degrees of freedom;
evaluating control signals in at least two degrees of freedom for navigation of a mark or an object on the display unit; and,
evaluating a third degree of freedom for selection of one of several discrete detail depth levels.

2. Method according to claim 1, comprising generating control signals by an additional degree of freedom and evaluating said control signals for alternate activation or deactivation of an object on a display unit.

3. Method according to claim 1, comprising displaying computer-assisted design objects on the display unit.

4. Method according to claim 1, comprising opening a control window of a graphic user interface displayed by a display device with at least one virtual switch surface for changing the adjustments of the input device by excursion of the input device in a specific degree of freedom or a combination of previously-established degrees of freedom, which is operable by excursion of the input device in at least one additional degree of freedom or a combination of additional previously-established degrees of freedom.

5. Method for controlling a computer unit with a display unit, on which directories and/or files of a tree-like directory with several hierarchical levels are displayed, in which the display directory levels or files are selectable, comprising:
generating control signals by an input device with at least three degrees of freedom;
evaluating control signals for navigation of a cursor or an object in the directory; and,
evaluating a third degree of freedom for alternate opening or closing of discrete directory levels or files.

6. Method according to claim 5, wherein the opening depth of the directory structure is a function of the distance of the directory from a focus chosen by the input device.

7. Method according to claim 5, comprising evaluating an additional degree of freedom of the input device to generate a control signal, and evaluating said control signal for alternate activation or deactivation of objects on display unit.

8. Method according to claim 5, comprising
displaying the directory structure in a first partial window of a graphic user interface;
displaying the subdirectories and/or files contained in a selected directory in a second partial window of the graphic user interface for identification and sorting by at least one member selected from the group consisting of graphic symbols, names, type designations, size, and creation date, further comprising changing the presentation view and/or arrangement of subdirectories and/or files displayed in the second partial window with respect to at least one member selected from the group consisting of graphic symbol name, type, size, and creation date by a first excursion of the input device in a first appropriately established degree of freedom for navigation through a list of possible view or arrangement types and a second excursion of the input device in another appropriately established degree of freedom for selection of a specific view or arrangement type.

9. Manually controlled operating element of an input device, which is subject to excursion in three different translatory and/or rotational degrees of freedom, comprising means to implement a method according to claim 1.

10. Computer software program product, to implement a method according to claim 1 when the product runs on a computer unit with a display unit.

11. System comprising
a computer unit,
a display unit connected to the computer unit, and
an input device that is subject to excursion in at least three degrees of freedom and is connected to the computer unit, wherein the computer unit is programmed to execute a method according to claim 1.
